(19) United States
(12) Patent Application Publication
(10) Pub. No.: US 2019/0204970 A1
(43) Pub. Date: Jul. 4, 2019

(54) ARRAY SUBSTRATE, TOUCH DISPLAY PANEL AND DISPLAY DEVICE

(71) Applicants: BOE Technology Group Co., Ltd., Beijing (CN); Ordos Yuansheng Optoelectronics Co., Ltd., Ordos (CN)

(72) Inventors: Peirong Huo, Beijing (CN); Zhiqiang Wang, Beijing (CN); Jingyi Xu, Beijing (CN); Fang Yan, Beijing (CN)

(73) Assignees: BOE TECHNOLOGY GROUP CO., LTD.; ORDOS YUANSHENG OPTOELECTRONICS CO., LTD

(21) Appl. No.: 16/170,330

(22) Filed: Oct. 25, 2018

(30) Foreign Application Priority Data
Jan. 2, 2018 (CN) 201810002491.1

(51) Int. Cl. G06F 3/041; G06F 3/044

(52) U.S. Cl. CPC G06F 3/0412; G06F 3/044; G06F 3/0416

(57) ABSTRACT

An array substrate, a touch display panel and a display device are provided. The array substrate includes: a common electrode and a conductive pattern which are on a base substrate, the common electrode includes a plurality of common electrode blocks arranged in an array; the conductive pattern includes a plurality of groups of connecting wires; each group of connecting wires is configured to electrically connect a touch driving circuit with one common electrode block; each group of connecting wires includes at least one conducting wire; each conducting wire includes a first conductive wire segment located in a lead region and a second conductive wire segment located in a connecting region and configured to connect the first conductive wire segment with the common electrode block; for each common electrode block group, the length of the second conductive wire segment is negatively correlated with the length of the first conductive wire segment.

This application claims the priority to the Chinese Patent Application No. 201810002491.1, filed on Jan. 2, 2018 and titled “ARRAY SUBSTRATE, TOUCH DISPLAY PANEL AND DISPLAY DEVICE, the disclosure of which are incorporated herein by reference in its entirety.

### TECHNICAL FIELD

The present disclosure relates to an array substrate, a touch display panel and a display device.

### BACKGROUND

An array substrate of a full-in-cell touch display panel usually includes a thin film transistor (TFT), touch pattern metal (TPM), a passivation layer, a common electrode, a flat layer and a pixel electrode which are stacked. The common electrode includes a plurality of common electrode blocks arranged in an array in a display region. The TPM includes a plurality of groups of metal wires. Each group of metal wires is connected with one common electrode block and a touch driving circuit respectively and is used to transmit a touch control signal between the common electrode block and the touch driving circuit.

### SUMMARY

The present disclosure provides an array substrate, a touch display panel and a display device.

According to an aspect of the present disclosure, there is provided an array substrate, comprising:

a common electrode and a conductive pattern which are on a base substrate, wherein the common electrode comprises a plurality of common electrode blocks in an arrangement of array; the conductive pattern comprises a plurality of groups of connecting wires; each group of connecting wires is configured to electrically connect a touch driving circuit with one of the common electrode blocks;

each group of connecting wires comprises at least one conducting wire; each conducting wire comprises a first conductive wire segment located in a lead region and a second conductive wire segment located in a connecting region and configured to connect the first conductive wire segment with the common electrode block;

for each common electrode block group, the length of the second conductive wire segment is negatively correlated with the length of the first conductive wire segment; and each common electrode block group comprises a plurality of common electrode blocks, of which an arrangement direction is parallel to an extension direction of any conducting wire.

Optionally, for the plurality of common electrode blocks comprised in each common electrode block group:

in any two common electrode blocks, if the length of the first conductive wire segment corresponding to the first common electrode block is less than the length of the first conductive wire segment corresponding to the second common electrode block, the length of the second conductive wire segment corresponding to the first common electrode block is greater than the length of the second conductive wire segment corresponding to the second common electrode block.

Optionally, each conducting wire is composed of the first conductive wire segment and the second conductive wire segment.

Optionally, each conducting wire further comprises a third conductive wire segment located in the connecting region and connected with the second conductive wire segment; and in a plurality of conducting wires comprised in the plurality of groups of connecting wires, the sums of the lengths of the third conductive wire segments and the second conductive wire segments of various conducting wires are equal.

Optionally, in a plurality of conducting wires comprised in the plurality of groups of connecting wires, at least two target conducting wires belonging to different groups exist; and in the at least two target conducting wires, the sums of the lengths of the first conductive wire segments and the second conductive wire segments are equal.

Optionally, in the plurality of conducting wires comprised in the plurality of groups of connecting wires, the sums of the lengths of the first conductive wire segments and the second conductive wire segments of various conducting wires are equal.

Optionally, in the plurality of conducting wires comprised in the plurality of groups of connecting wires, at least two target conducting wires belonging to different groups exist; in the at least two target conducting wires, the lengths of the first conductive wire segments of various target conducting wires are equal; and the lengths of the second conductive wire segments of various target conducting wires are equal.

Optionally, each group of connecting wires comprises at least two conducting wires.

Optionally, the at least two conducting wires share one first conductive wire segment.

Optionally, a passivation layer is further arranged between the common electrode and the conductive pattern; there are a plurality of via hole groups on the passivation layer; each group of connecting wires is electrically connected with the common electrode block through one via hole group; and the plurality of via hole groups is in one-to-one correspondence with the plurality of groups of connecting wires.

Optionally, each group of connecting wires comprises at least one conducting wire; each via hole group comprises at least one via hole; each conducting wire is electrically connected with the common electrode block through one via hole; and the at least one conducting wire is in one-to-one correspondence with the at least one via hole.

Optionally, each group of connecting wires comprises at least one conducting wire; each via hole group comprises at least one sub via hole group; each sub via hole group comprises a plurality of via holes; each conducting wire is electrically connected with the common electrode block through one sub via hole group; and the at least one conducting wire is in one-to-one correspondence with the at least one sub via hole group.

Optionally, the conductive pattern is a transparent conductive pattern.

Optionally, the transparent conductive pattern is touch pattern metal (TPM); and the conducting wire is a metal wire.

Optionally, the transparent conductive pattern is a graphene pattern; and the conducting wire is a graphene conducting wire.

Optionally, the conducting wire is made of indium tin oxide (ITO).

Optionally, the common electrode is on the side, away from the base substrate, of the conductive pattern.

Optionally, the common electrode is on the side, close to the base substrate, of the conductive pattern.

According to another aspect of the present disclosure, there is provided a touch display panel, comprising: a touch driving circuit and an array substrate, wherein the array substrate comprises:

a common electrode and a conductive pattern which are on a base substrate, wherein the common electrode comprises a plurality of common electrode blocks in an arrangement of array; the conductive pattern comprises a plurality of groups of connecting wires; each group of connecting wires is configured to electrically connect a touch driving circuit with one of the common electrode blocks;

each group of connecting wires comprises at least one conducting wire; each conducting wire comprises a first conductive wire segment located in a lead region and a second conductive wire segment located in a connecting region and configured to connect the first conductive wire segment with the common electrode block;

for each common electrode block group, the length of the second conductive wire segment is negatively correlated with the length of the first conductive wire segment; and each common electrode block group comprises a plurality of common electrode blocks, of which an arrangement direction is parallel to an extension direction of any conducting wire.

According to yet another aspect of the present disclosure, there is provided a display device, comprising a touch display panel, wherein the touch display panel comprises: a touch driving circuit and an array substrate, the array substrate comprising:

a common electrode and a conductive pattern which are on a base substrate, wherein the common electrode comprises a plurality of common electrode blocks in an arrangement of array; the conductive pattern comprises a plurality of groups of connecting wires; each group of connecting wires is configured to electrically connect a touch driving circuit with one of the common electrode blocks;

each group of connecting wires comprises at least one conducting wire; each conducting wire comprises a first conductive wire segment located in a lead region and a second conductive wire segment located in a connecting region and configured to connect the first conductive wire segment with the common electrode block;

for each common electrode block group, the length of the second conductive wire segment is negatively correlated with the length of the first conductive wire segment; and each common electrode block group comprises a plurality of common electrode blocks, of which an arrangement direction is parallel to an extension direction of any conducting wire.

### BRIEF DESCRIPTION OF THE DRAWINGS

FIG. 1 is a schematic diagram of a structure of an array substrate according to an embodiment of the present disclosure;

FIG. 2 is a schematic diagram of a structure of another array substrate according to an embodiment of the present disclosure;

FIG. 3 is a schematic diagram of a structure of yet another array substrate according to an embodiment of the present disclosure

FIG. 4 is a schematic diagram of a partial structure of an array substrate according to an embodiment of the present disclosure; and

FIG. 5 is a curve diagram of capacitance values of 30 common electrode blocks of a tested array substrate according to an embodiment of the present disclosure.

### DETAILED DESCRIPTION

In order to make the principle and advantages of the present disclosure clearer, the embodiments of the present disclosure will be further described in details below with reference to the accompanying drawings.

As known by the inventor, a touch driving circuit is generally arranged at a middle position of one side edge of a touch display panel. In a plurality of metal wires included in a plurality of groups of metal wires, each metal wire may include a metal segment located in a lead region and a metal segment located in a display region. The lengths of the metal segments, located in the display regions, of various metal wires are equal. For each column of common electrode blocks, the lengths of effective metal segments connected between various common electrode blocks and the touch driving circuit and located in the display region increase in a sequence from near to far according to the distances from the common electrode blocks to the touch driving circuit. For each row of common electrode blocks, the lengths of effective metal segments connected between various common electrode blocks and the touch driving circuit and located in the display region are equal. According to the sequence of common electrode columns on the display panel from left to right, the length of the metal segment in the lead region on the display panel firstly decreases and then increases. As a result, both the length of the metal segment in the lead region and the length of the effective metal segment are distributed within a relatively large length range, which causes poor length uniformity of the effective metal segments connected between the common electrode block and the touch driving circuit and located in the display region. Since the resistance of the metal wire is proportional to the length of the metal wire, the uniformity of the resistance of the metal wires on the whole touch panel is relatively poor (namely, presents a relatively large difference), which affects the touch accuracy of the touch display panel.

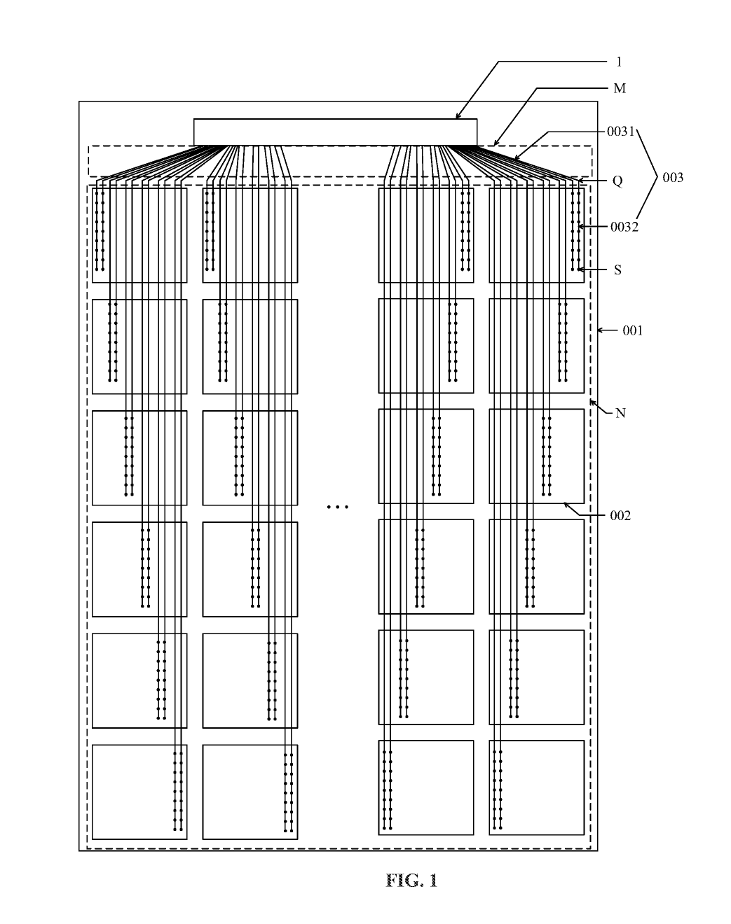

FIG. 1 is a structural diagram of an array substrate provided in an embodiment of the present disclosure. As shown in FIG. 1, the array substrate may include:

A common electrode and a conductive pattern are on a base substrate 001. The common electrode may include a plurality of common electrode blocks 002 arranged in an array. The conductive pattern includes a plurality of groups of connecting wires. Each group of connecting wires includes at least one conducting wire 003. Each group of connecting wires is configured to electrically connect a touch driving circuit 1 with one common electrode block 002. The resistance of each conducting wire 003 is proportional to the length of the conducting wire 003. For example, in the structure shown in FIG. 1, each group of connecting wires includes two conducting wires, namely, each common electrode block 002 is connected with the touch driving circuit 1 through two conducting wires.

Each conducting wire 003 may include a first conductive wire segment 0031 located in a lead region M and a second conductive wire segment 0032 located in a connecting region N and configured to connect the first conductive wire segment 0031 with the common electrode block 002. That is, in FIG. 1, a conducting wire segment from an intersection Q of the lead region M and the connecting region N to an output end of the touch driving circuit 1 is the first conductive wire segment 0031, and a conducting wire segment from a connecting position S of the conducting wire and the common electrode block to the intersection Q is the second conductive wire segment 0032. Exemplarily, the lead region may be a fan-out region. The connecting region may be a display region of a display panel.

For each common electrode block group, the length of the second conductive wire segment 0032 is negatively correlated with the length of the first conductive wire segment 0031. Each common electrode block group includes a plurality of common electrode blocks 002 arranged in a direction parallel to an extension direction of any conducting wire 003.

Optionally, the conductive pattern may be a transparent conductive pattern. The transparent conductive pattern may be TPM. The conducting wire may be a metal wire. The material from which the conducting wire is made may be ITO. Alternatively, the transparent conductive pattern may be a graphene pattern. The conducting wire may be a graphene conducting wire.

In some embodiments, the array substrate may further include film layers such as a TFT and a flat layer, etc. which are arranged on the base substrate 001. In addition, the common electrode may be arranged on the side, away from the base substrate 001, of the conductive pattern and may also be arranged on the side, close to the base substrate 001, of the conductive pattern.

To sum up, for the array substrate provided in the embodiment of the present disclosure, in each common electrode block group, the length of the second conductive wire segment is negatively correlated with the first conductive wire segment, so that the length distribution range of the plurality of conducting wires in the conductive pattern may be controlled within a relatively small range. When the present disclosure is compared with the related art, the length uniformity of the conducting wires is improved, thus the resistance uniformity of the conducting wires is improved and the touch accuracy of the touch display panel is improved.

The expression that the length of the second conductive wire segment 0032 is negatively correlated with the first conductive wire segment 0031 refers to that for the plurality of common electrode blocks 002 included in each common electrode block group, in any two common electrode blocks 002, if the length of the first conductive wire segment 0031 corresponding to the first common electrode block is less than the length of the first conductive wire segment 0031 corresponding to the second common electrode block, the length of the second conductive wire segment 0032 corresponding to the first common electrode block is greater than the length of the second conductive wire segment 0032 corresponding to the second common electrode block.

Each group of connecting wires may include at least two conducting wires. The at least two conducting wires may be connected in parallel between the touch driving circuit 1 and the common electrode block 002. Therefore, the total resistance of the conducting wires connecting the touch driving circuit 1 and the common electrode block 002 is reduced and thus the degree of effects of the conducting wire resistance on the touch accuracy of the touch display panel is reduced.

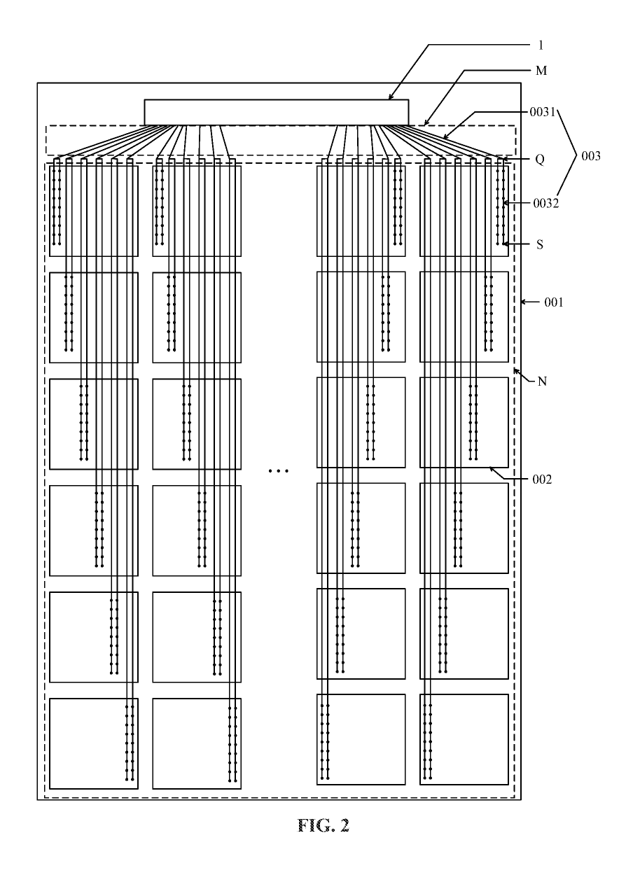

FIG. 2 is a structural diagram of another array substrate provided in an embodiment of the present disclosure. As shown in FIG. 2, the at least two conducting wires may share one first conductive wire segment 0031. That is, one first conductive wire segment 0031 which is shared may constitute a conducting wire with different second conductive wire segments 0032 respectively. When the at least two conducting wires share one first conductive wire segment 0031, the number of the first conductive wire segments 0031 arranged in the lead region may be reduced, thereby simplifying a manufacturing process of the first conductive wire segment 0031. In addition, since the number of the first conductive wire segments 0031 is reduced, the wire width of the first conductive wire segment 0031 manufactured may be increased properly, the process difficulty of manufacturing the first conductive wire segment 0031 is reduced and thus the effective connection between the common electrode block 002 and the touch driving circuit 1 is guaranteed.

With reference to FIGS. 1 and 2, each conducting wire 003 may be only composed of the first conductive wire segment 0031 and the second conductive wire segment 0032. When the conducting wire 003 is only composed of the first conductive wire segment 0031 and the second conductive wire segment 0032, useless conductive wire segments in the connecting region are eliminated in comparison with the related art. Therefore, mutual capacitance between the conductive wire segments may be reduced and thus the resistance of the conducting wire is reduced.

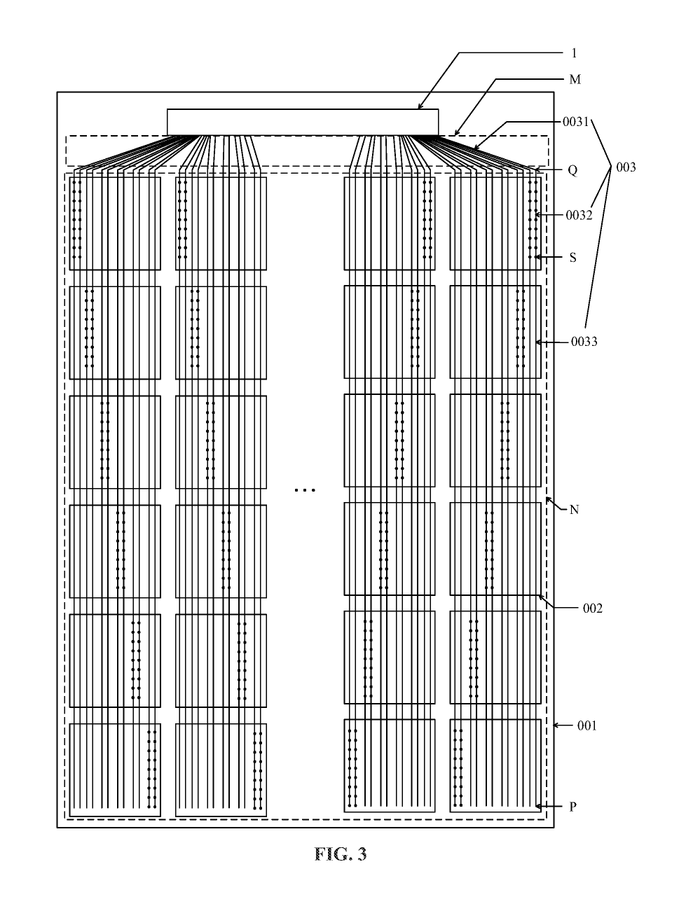

FIG. 3 is a structural diagram of still another array substrate provided in an embodiment of the present disclosure. As shown in FIG. 3, each conducting wire 003 may further include a third conductive wire segment 0033 which is located in the connecting region N and connected with the second conductive wire segment 0032. In FIG. 3, a conducting wire segment from the connecting position S of the conducting wire and the common electrode block to an edge position P of the touch display panel is the third conductive wire segment 0033. In the plurality of conducting wires included in the plurality of groups of connecting wires, the sums of the lengths of the third conductive wire segments 0033 and the second conductive wire segments 0032 of respective the conducting wires 003 are equal. When the conductive pattern is arranged in this manner, the shapes of all the conducting wires 003 located in the connecting region are the same. Thus a mask used in manufacturing the conductive pattern is simple in structure and a manufacturing process of the conductive pattern is simplified.

In the plurality of conducting wires included in the plurality of groups of connecting wires, at least two target conducting wires belonging to different groups may exist. In the at least two target conducting wires, the sums of the lengths of the first conductive wire segments 0031 and the lengths of the second conductive wire segments 0032 of respective target conducting wires are equal. When the sums of the lengths of the first conductive wire segments 0031 and the lengths of the second conductive wire segments 0032 of the target conducting wires are equal, the length uniformity of the conducting wires may be further improved. In addition, since the resistance of the conducting wire is proportional to the length thereof, the resistance uniformity of the conducting wires may be further improved.

Alternatively, in the plurality of conducting wires included in the plurality of groups of connecting wires, the sums of the lengths of the first conductive wire segments 0031 and the second conductive wire segments 0032 of respective conducting wires 003 may also be equal (not shown). At this time, the lengths of the conducting wires which connect the touch driving circuit and all the common electrode blocks on the whole touch display panel are equal. Thus, the length uniformity of the conducting wire may be further improved. In addition, since the resistance of the conducting wire is proportional to the length thereof, the resistance uniformity of the conducting wires may be further improved.

In some embodiments, in the plurality of conducting wires included in the plurality of groups of connecting wires, at least two target conducting wires belonging to different groups may further exist. In the at least two target conducting wires, the lengths of the first conductive wire segments 0031 of respective target conducting wires are equal and the lengths of the second conductive wire segments 0032 of respective target conducting wires are equal. When the lengths of the first conductive wire segments 0031 of respective target conducting wires are equal and the lengths of the second conductive wire segments 0032 of respective target conducting wires are equal, the length uniformity of the conducting wires may also be improved further, that is, the resistance uniformity of the conducting wires may be further improved.

Optionally, a passivation layer (not shown) is further arranged between the common electrode and the conductive pattern. A plurality of via hole groups is arranged on the passivation layer. The plurality of via hole groups is in one-to-one correspondence with the plurality of groups of connecting wires. Each group of connecting wires is electrically connected with the common electrode block 002 through one via hole group corresponding to the group of connecting wires.

In some embodiments, each group of connecting wires may include at least one conducting wire 003. Each via hole group includes at least one via hole. The at least one conducting wire 003 is in one-to-one correspondence with the at least one via hole. Each conducting wire 003 is electrically connected with the common electrode block 002 through a via hole corresponding to the conducting wire 003.

Since the conducting wire 003 and the common electrode block 002 are connected in a connection mode of “one wire and one via hole”, when each group of connecting wires includes a plurality of conducting wires, the plurality of conducting wires may be connected in parallel between the touch driving circuit 1 and the common electrode block 002, thereby reducing the total resistance of the conducting wires which connect the touch driving circuit with the common electrode block.

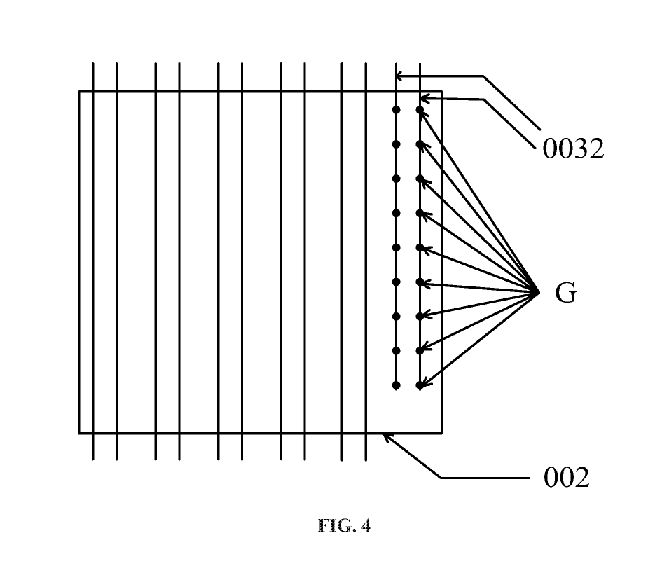

In some embodiments, each group of connecting wires may include at least one conducting wire 003. Each via hole group includes at least one sub via hole group. The at least one conducting wire 003 is in one-to-one correspondence with the at least one sub via hole group. Each sub via hole group includes a plurality of via holes. Each conducting wire 003 is electrically connected with the common electrode block 002 through one sub via hole group corresponding to the conducting wire. For example, FIG. 4 is a partial structural diagram of an array substrate provided in an embodiment of the present disclosure. As shown in FIG. 4, each group of connecting wires includes two conducting wires. Each via hole group includes two sub via hole groups. One sub via hole group includes nine via holes G. The second conductive wire segment 0032 in one conducting wire is connected with the common electrode block 002 through one sub via hole group. The second conductive wire segment 0032 in the other conducting wire is connected with the common electrode block 002 through the other sub via hole group.

When each group of connecting wires includes one conducting wire 003, the one conducting wire 003 is connected with the common electrode block 002 through the plurality of via holes corresponding to the conducting wire. Thus, the one conducting wire 003 may be divided into a plurality of conducting wire segments by the plurality of via holes. The plurality of conducting wire segments may be connected in parallel between the touch driving circuit 1 and the common electrode block 002 through the via holes, thereby further reducing connecting resistance. When each group of connecting wires includes a plurality of conducting wires, each of the plurality of conducting wires 003 is connected with the same common electrode block 002 through the plurality of via holes corresponding to the conducting wires. In each conducting wire, the plurality of conducting wire segments divided by the plurality of via holes may be connected in parallel between the touch driving circuit 1 and the common electrode block 002 through via holes so as to reduce the connecting resistance. In addition, the plurality of conducting wires may also be connected in parallel between the touch driving circuit 1 and the common electrode block 002. Therefore, the total resistance of the conducting wires which connect the touch driving circuit with the common electrode block is reduced and thus the degree of effects of the resistance on the touch control accuracy of the touch display panel is reduced.

Usually, the effect of a resistance value on the touch control accuracy mainly presents as affecting the size of a capacitance value of a touch electrode, and the larger the capacitance value, the smaller the touch control accuracy.

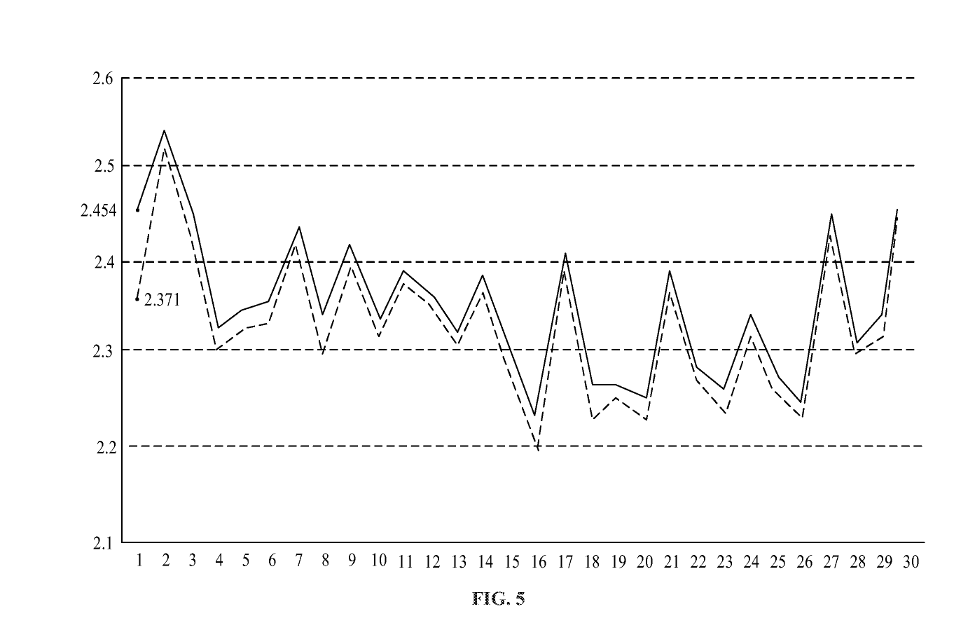

FIG. 5 is a curve diagram of capacitance values of 30 common electrode blocks of a tested array substrate provided in an embodiment of the present disclosure. As shown in FIG. 5, the solid line in FIG. 5 refers to a curve of capacitance values of respective common electrode blocks in the related art, and the dashed line in FIG. 5 refers to a curve of capacitance values of respective common electrode blocks when the conductive pattern on the array substrate is a pattern shown in FIG. 3. It can be seen from FIG. 5 that the capacitance value of the first common electrode block corresponding to the present disclosure is 2.371. The capacitance value of the first common electrode block corresponding to the related art is 2.454. The capacitance value of the first common electrode block corresponding to the present disclosure is reduced by 0.083 in comparison with the related art. Therefore, the array substrate provided in the embodiment of the present disclosure reduces the degree of effects of the resistance uniformity of the conducting wires on the touch control accuracy of the touch display panel.

With respect to the related art, the array substrate provided in the embodiments of the present disclosure can control the distribution range of the length of the plurality of conducting wires in the conductive pattern within a relatively small range by setting the length of the second conductive wire segment to be negatively correlated with the first conductive wire segment in each common electrode block group. Compared with the related art, the length uniformity of the conducting wires is improved, thus the resistance uniformity of the conducting wires is improved and the touch control accuracy of the touch display panel is improved.

The present disclosure further provides a touch display panel which may include a touch driving circuit 1 and the array substrate provided in the above embodiments. Exemplarily, the array substrate may be the array substrate shown in FIG. 1, 2 or 3.

To sum up, for the touch display panel provided in the embodiments of the present disclosure, in each common electrode block group on the array substrate, by setting the length of the second conductive wire segment to be negatively correlated with the first conductive wire segment, the length distribution range of the plurality of conducting wires in the conductive pattern can be controlled within the relatively small range. Compared with the related art, the length uniformity of the conducting wires is improved and the resistance uniformity of the conducting wires is improved. Thus, the degree of effects of the resistance uniformity of the conducting wires on the touch control accuracy of the touch display panel is reduced. Therefore, the yield of products may be increased.

Additionally, the present disclosure further provides a display device, comprising the touch display panel provided by the above embodiments. The display device may be any products or parts with a display function, such as a liquid crystal panel, an electronic paper, a mobile phone, a tablet computer, a TV, a display, a laptop computer, a digital photo frame, a navigator, etc.

The foregoing descriptions are merely exemplary embodiments of the present disclosure, and are not intended to limit the present disclosure. Within the spirit and principles of the disclosure, any modifications, equivalent substitutions, improvements, etc., are within the protection scope of the appended claims of the present disclosure.

What is claimed is:

1. An array substrate comprising:
a common electrode and a conductive pattern which are on a base substrate, wherein the common electrode comprises a plurality of common electrode blocks in an arrangement of array; the conductive pattern comprises a plurality of groups of connecting wires; each group of connecting wires is configured to electrically connect a touch driving circuit with one of the common electrode blocks;
each group of connecting wires comprises at least one conducting wire; each conducting wire comprises a first conductive wire segment in a lead region and a second conductive wire segment in a connecting region and configured to connect the first conductive wire segment with the common electrode block;
for each common electrode block group, the length of the second conductive wire segment is negatively correlated with the length of the first conductive wire segment; and each common electrode block group comprises a plurality of common electrode blocks, of which an arrangement direction is parallel to an extension direction of any conducting wire.

2. The array substrate according to claim 1, wherein
for the plurality of common electrode blocks comprised in each common electrode block group:
in any two common electrode blocks, if the length of the first conductive wire segment corresponding to the first common electrode block is less than the length of the first conductive wire segment corresponding to the second common electrode block, the length of the second conductive wire segment corresponding to the first common electrode block is greater than the length of the second conductive wire segment corresponding to the second common electrode block.

3. The array substrate according to claim 1, wherein each conducting wire is composed of the first conductive wire segment and the second conductive wire segment.

4. The array substrate according to claim 1, wherein each conducting wire further comprises a third conductive wire segment in the connecting region and connected with the second conductive wire segment; and in a plurality of conducting wires comprised in the plurality of groups of connecting wires, the sums of the lengths of the third conductive wire segments and the second conductive wire segments of various conducting wires are equal.

5. The array substrate according to claim 1, wherein in a plurality of conducting wires comprised in the plurality of groups of connecting wires, at least two target conducting wires belonging to different groups exist; and in the at least two target conducting wires, the sums of the lengths of the first conductive wire segments and the second conductive wire segments are equal.

6. The array substrate according to claim 5, wherein in the plurality of conducting wires comprised in the plurality of groups of connecting wires, the sums of the lengths of the first conductive wire segments and the second conductive wire segments of various conducting wires are equal.

7. The array substrate according to claim 1, wherein in the plurality of conducting wires comprised in the plurality of groups of connecting wires, at least two target conducting wires belonging to different groups exist; in the at least two target conducting wires, the lengths of the first conductive wire segments of various target conducting wires are equal; and the lengths of the second conductive wire segments of various target conducting wires are equal.

8. The array substrate according to claim 1, wherein each group of connecting wires comprises at least two conducting wires.

9. The array substrate according to claim 8, wherein the at least two conducting wires share one first conductive wire segment.

10. The array substrate according to claim 1, wherein a passivation layer is further existed between the common electrode and the conductive pattern; there are a plurality of via hole groups on the passivation layer; each group of connecting wires is electrically connected with the common electrode block through one via hole group; and the plurality of via hole groups is in one-to-one correspondence with the plurality of groups of connecting wires.

11. The array substrate according to claim 10, wherein each group of connecting wires comprises at least one conducting wire; each via hole group comprises at least one via hole; each conducting wire is electrically connected with the common electrode block through one via hole; and the at least one conducting wire is in one-to-one correspondence with the at least one via hole.

12. The array substrate according to claim 10, wherein each group of connecting wires comprises at least one conducting wire; each via hole group comprises at least one sub via hole group; each sub via hole group comprises a plurality of via holes; each conducting wire is electrically connected with the common electrode block through one sub via hole group; and the at least one conducting wire is in one-to-one correspondence with the at least one sub via hole group.

13. The array substrate according to claim 1, wherein the conductive pattern is a transparent conductive pattern.

14. The array substrate according to claim 13, wherein the transparent conductive pattern is touch pattern metal (TPM); and the conducting wire is a metal wire.

15. The array substrate according to claim 14, wherein the transparent conductive pattern is a graphene pattern; and the conducting wire is a graphene conducting wire.

16. The array substrate according to claim 14, wherein the conducting wire is made of indium tin oxide ITO.

17. The array substrate according to claim 1, wherein the common electrode is on the side, away from the base substrate, of the conductive pattern.

18. The array substrate according to claim 1, wherein the common electrode is on the side, close to the base substrate, of the conductive pattern.

19. A touch display panel, comprising: a touch driving circuit and an array substrate, wherein the array substrate comprises:
a common electrode and a conductive pattern which are on a base substrate, wherein the common electrode comprises a plurality of common electrode blocks in an arrangement of array; the conductive pattern comprises a plurality of groups of connecting wires; each group of connecting wires is configured to electrically connect a touch driving circuit with one of the common electrode blocks;
each group of connecting wires comprises at least one conducting wire; each conducting wire comprises a first conductive wire segment located in a lead region and a second conductive wire segment located in a connecting region and configured to connect the first conductive wire segment with the common electrode block;
for each common electrode block group, the length of the second conductive wire segment is negatively correlated with the length of the first conductive wire segment; and each common electrode block group comprises a plurality of common electrode blocks, of which an arrangement direction is parallel to an extension direction of any conducting wire.

20. A display device, comprising a touch display panel comprising a touch driving circuit and an array substrate, wherein the array substrate comprises:
a common electrode and a conductive pattern which are on a base substrate, wherein the common electrode comprises a plurality of common electrode blocks in an arrangement of array; the conductive pattern comprises a plurality of groups of connecting wires; each group of connecting wires is configured to electrically connect a touch driving circuit with one of the common electrode blocks;
each group of connecting wires comprises at least one conducting wire; each conducting wire comprises a first conductive wire segment located in a lead region and a second conductive wire segment located in a connecting region and configured to connect the first conductive wire segment with the common electrode block;
for each common electrode block group, the length of the second conductive wire segment is negatively correlated with the length of the first conductive wire segment; and each common electrode block group comprises a plurality of common electrode blocks, of which an arrangement direction is parallel to an extension direction of any conducting wire.
